(19) United States
(12) Patent Application Publication
(10) Pub. No.: US 2010/0118509 A1
(43) Pub. Date: May 13, 2010

(54) LIGHT SOURCE PACKAGE, LIQUID CRYSTAL DISPLAY DEVICE INCLUDING LIGHT SOURCE PACKAGE, AND METHOD OF MANUFACTURING THE SAME

(76) Inventors: Jae-Joong KWON, Suwon-si (KR); Hyoung-Joo Kim, Ewang-si (KR); Sung-Kyu Shim, Seoul (KR); Seung-In Baek, Seoul (KR)

Correspondence Address: Haynes and Boone, LLP;IP Section, 2323 Victory Avenue, SUITE 700, Dallas, TX, 75219, US

(21) Appl. No.: 12/484,832

(22) Filed: Jun. 15, 2009

(30) Foreign Application Priority Data
Nov. 11, 2008 (KR) 10-2008-0111700

(51) Int. Cl. G02F 1/13357; F21V 7/06; F21V 9/16

(52) U.S. Cl. 362/84; 362/296.01; 362/296.07; 362/97.2

(57) ABSTRACT

Provided are, a light source package having a large emission area and a low manufacturing cost, a liquid crystal display device including the light source package, and a method of manufacturing the same. The light source package includes: a package case including a bottom plate having a bottom plate flat portion, and a light source mounting plate that is formed by bending at least one end of the bottom plate and has a first inclination angle with respect to the bottom plate flat portion; a light source mounted on the light source mounting plate; and a package reflecting portion formed in the package case so as to have a second inclination angle with respect to the bottom plate flat portion and reflecting light emitted from the light source.

### CROSS-REFERENCE TO RELATED APPLICATION

This application claims priority from Korean Patent Application No. 10-2008-0111700 filed on Nov. 11, 2008 in the Korean Intellectual Property Office, the disclosure of which is incorporated herein by reference in its entirety.

### BACKGROUND OF THE INVENTION

1. Field of the Invention

The present invention relates to a light source package, a liquid crystal display device including a light source package, and a method of manufacturing the same, and more particularly, to a light source package having a large emission area and a low manufacturing cost, a liquid crystal display device including a light source package, and a method of manufacturing the same.

2. Description of the Related Art

A liquid crystal display (LCD) is one of the most commonly used flat panel displays (FPDs) and includes two substrates having electrodes formed thereon and a liquid crystal layer interposed therebetween. When a voltage is applied between the electrodes, liquid crystal molecules in the liquid crystal layer are rearranged to adjust the quantity of transmitted light.

Since the liquid crystal display device is not a self-emission display device, it includes a backlight assembly that emits light to a liquid crystal panel.

The backlight assembly includes, for example, a light source, a light guide plate, a plurality of optical sheets, and a reflecting sheet. A plurality of light sources may be arranged on at least one side of the light guide plate.

However, a dark portion is formed in a space between the plurality of light sources, which may cause uneven distribution of light emitted from the liquid crystal panel.

### SUMMARY OF THE INVENTION

An aspect of the present invention provides a light source package having a large emission area and a low manufacturing cost.

Another aspect of the present invention provides a method of manufacturing a light source package having a large emission area and a low manufacturing cost.

Still another aspect of the present invention provides a liquid crystal display device including a light source package having a large emission area and a low manufacturing cost.

Yet another aspect of the present invention provides a method of manufacturing a liquid crystal display device including a light source package having a large emission area and a low manufacturing cost.

However, the aspects, features and advantages of the present invention are not restricted to the ones set forth herein. The above and other aspects, features and advantages of the present invention will become more apparent to one of ordinary skill in the art to which the present invention pertains by referencing a detailed description of the present invention given below.

According to an aspect of the present invention, a light source package includes: a package case including a bottom plate having a bottom plate flat portion, and a light source mounting plate that is formed by bending at least one end of the bottom plate and has a first inclination angle with respect to the bottom plate flat portion; a light source mounted on the light source mounting plate; and a package reflecting portion formed in the package case so as to have a second inclination angle with respect to the bottom plate flat portion and reflecting light emitted from the light source.

According to another aspect of the present invention, a light source package includes: a package case including a bottom plate and a plurality of package side walls formed along the edge of the bottom plate; a light source mounted on the bottom plate; and a package reflecting portion formed so as to be inclined with respect to the bottom plate and reflecting light emitted from the light source.

According to still another aspect of the present invention, there is provided a method of manufacturing a light source package, the method including: providing a package case including a bottom plate having a bottom plate flat portion and a light source mounting plate that is formed by bending at least one end of the bottom plate and has a first inclination angle with respect to the bottom plate flat portion, and a package reflecting portion formed in the package case so as to have a second inclination angle with respect to the bottom plate flat portion; and filling the package case with a protective resin.

According to yet another aspect of the present invention, a liquid crystal display device includes: a light guide plate; at least one light source package provided on at least one side of the light guide plate; and a lower receptacle accommodating the light guide plate and the light source package. The light source package includes: a package case including a bottom plate having a bottom plate flat portion, and a light source mounting plate that is formed by bending at least one end of the bottom plate and has a first inclination angle with respect to the bottom plate flat portion; a light source mounted on the light source mounting plate; and a package reflecting portion formed in the package case so as to have a second inclination angle with respect to the bottom plate flat portion and reflecting light emitted from the light source.

According to still yet another aspect of the present invention, a liquid crystal display device includes: a light guide plate; at least one light source package provided on at least one side of the light guide plate; and a lower receptacle accommodating the light guide plate and the light source package. The light source package includes: a package case including a bottom plate and a plurality of package side walls formed along the edge of the bottom plate; a light source mounted on the bottom plate; and a package reflecting portion formed so as to be inclined with respect to the bottom plate and reflecting light emitted from the light source.

According to yet still another aspect of the present invention, there is provided a method of manufacturing a liquid crystal display device, the method including: manufacturing a light source package by providing a package case including a bottom plate having a bottom plate flat portion and a light source mounting plate that is formed by bending at least one end of the bottom plate and has a first inclination angle with respect to the bottom plate flat portion, and a package reflecting portion formed in the package case so as to have a second inclination angle with respect to the bottom plate flat portion, and by filling the package case with a protective resin; and arranging the light source package on at least one side of the light guide plate.

### BRIEF DESCRIPTION OF THE DRAWINGS

The above and other aspects and features of the present invention will become more apparent by describing in detail exemplary embodiments thereof with reference to the attached drawings, in which:

FIG. 1 is an exploded perspective view illustrating a liquid crystal display device according to a first embodiment of the present invention;

FIG. 2 is a perspective view illustrating a light source package of the liquid crystal display device according to the first embodiment of the present invention;

FIG. 3A is a diagram schematically illustrating the light source package of the liquid crystal display device according to the first embodiment of the present invention;

FIG. 3B is a diagram schematically illustrating a light source package of a liquid crystal display device according to a modification of the first embodiment of the present invention;

FIG. 4 is a diagram schematically illustrating a light source package of a liquid crystal display device according to a second embodiment of the present invention;

FIG. 5 is a diagram schematically illustrating a light source package of a liquid crystal display device according to a third embodiment of the present invention;

FIG. 6 is a diagram schematically illustrating a light source package of a liquid crystal display device according to a fourth embodiment of the present invention;

FIG. 7 is a diagram schematically illustrating a light source package of a liquid crystal display device according to a fifth embodiment of the present invention;

FIG. 8 is a diagram schematically illustrating a light source package of a liquid crystal display device according to a sixth embodiment of the present invention;

FIG. 9 is a diagram schematically illustrating a light source package of a liquid crystal display device according to a seventh embodiment of the present invention;

FIG. 10 is a diagram schematically illustrating a light source package of a liquid crystal display device according to an eighth embodiment of the present invention;

FIG. 11 is a diagram schematically illustrating a light source package of a liquid crystal display device according to a ninth embodiment of the present invention;

FIG. 12 is a diagram schematically illustrating a light source package of a liquid crystal display device according to a tenth embodiment of the present invention;

FIG. 13 is a diagram schematically illustrating a light source package of a liquid crystal display device according to an eleventh embodiment of the present invention;

FIG. 14 is a diagram schematically illustrating a light source package of a liquid crystal display device according to a twelfth embodiment of the present invention;

FIG. 15 is a diagram schematically illustrating a light source package of a liquid crystal display device according to a thirteenth embodiment of the present invention;

FIG. 16 is a diagram schematically illustrating a light source package of a liquid crystal display device according to a fourteenth embodiment of the present invention;

FIG. 17 is a diagram schematically illustrating a gap between the light source packages according to the embodiments of the present invention;

FIGS. 18A and 18B are diagrams schematically illustrating the length of the light source package according to the embodiments of the present invention and the length of a light source package according to a comparative example;

FIGS. 19A and 19B are diagrams schematically illustrating the brightness distribution of the light source package according to the embodiments of the present invention and the brightness distribution of the light source package according to the comparative example;

FIGS. 20A and 20B are diagrams schematically illustrating the light quantity distribution of the light source package according to the embodiments of the present invention and the light quantity distribution of the light source package according to the comparative example;

FIGS. 21A and 21B are diagrams schematically illustrating the area of a dark portion in the liquid crystal display device according to the embodiments of the present invention and the area of a dark portion in a liquid crystal display device according to the comparative example; and

FIGS. 22A and 22B to 28 are diagrams illustrating processes of a method of manufacturing a liquid crystal display device according to a fifteenth embodiment of the present invention.

### DETAILED DESCRIPTION OF THE EXEMPLARY EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Examples of a liquid crystal display device used in the present invention include a notebook computer, a monitor, a PMP (portable multimedia player), a PDA (personal digital assistant), a portable DVD (digital versatile disk) player, and a cellular phone.

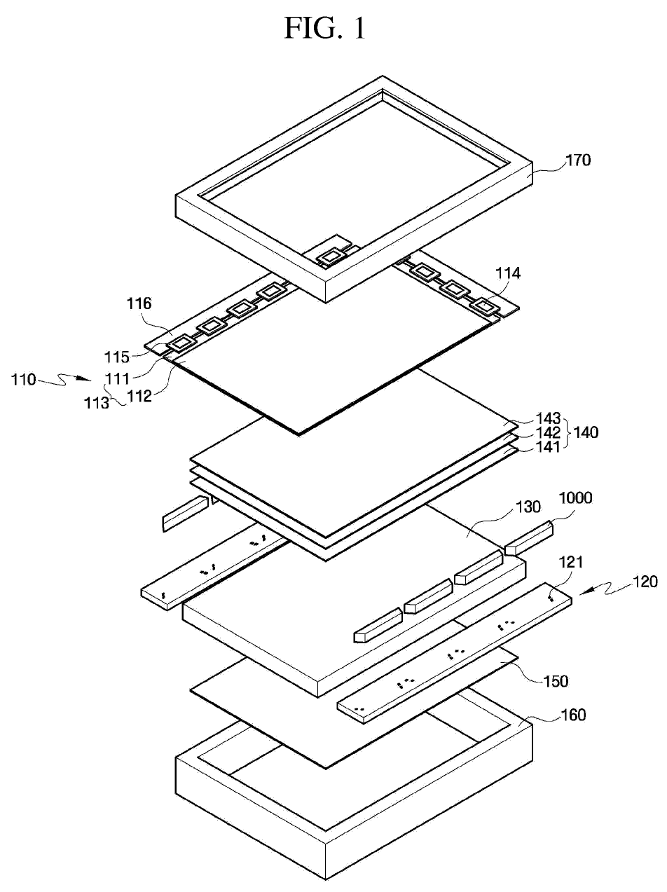

Hereinafter, a liquid crystal display device according to a first embodiment of the present invention will be described in detail with reference to FIGS. 1 to 3B.

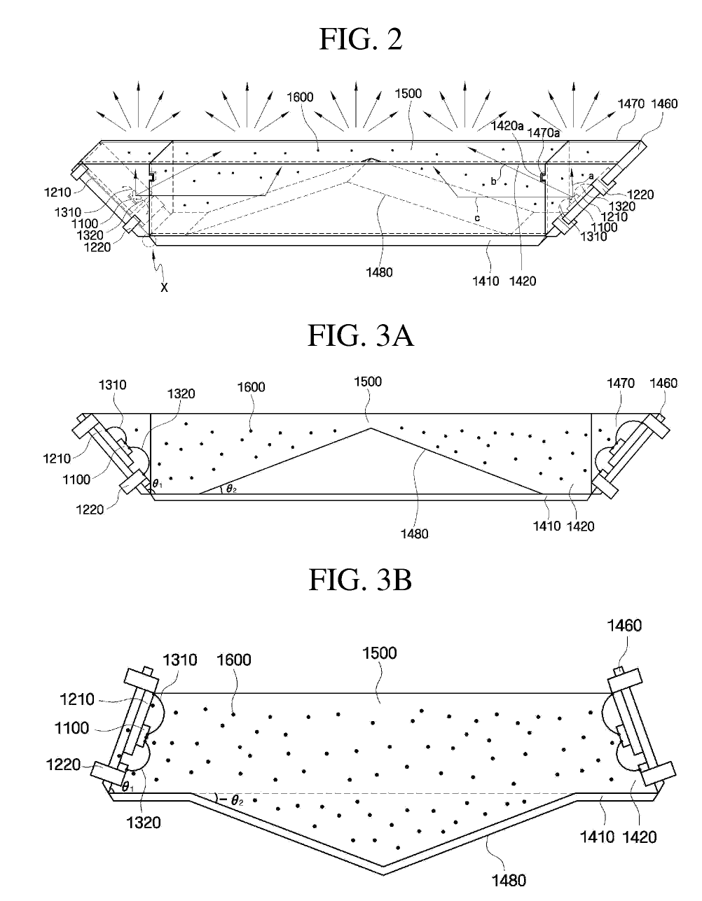

FIG. 1 is an exploded perspective view illustrating the liquid crystal display device according to the first embodiment of the present invention. FIG. 2 is a perspective view illustrating a light source package of the liquid crystal display device according to the first embodiment of the present invention. FIG. 3A is a diagram schematically illustrating the light source package of the liquid crystal display device according to the first embodiment of the present invention.

Referring to FIG. 1, the liquid crystal display device according to this embodiment of the present invention includes a liquid crystal panel assembly 110, a light source package 1000, an alignment plate 120, a light guide plate 130, an optical sheet 140, a reflecting sheet 150, a lower receptacle 160, and an upper receptacle 170. The liquid crystal panel assembly 110 includes a liquid crystal panel 113 including a thin film transistor substrate 111 and a color filter substrate 112, liquid crystal (not shown), a gate tape carrier package 114, a data tape carrier package 115, and a printed circuit board 116.

The liquid crystal panel 113 includes the thin film transistor substrate 111 that includes gate lines (not shown), data lines (not shown), a thin film transistor array, and pixel electrodes, and the color filter substrate 112 that includes a black matrix and a common electrode and is provided so as to face the thin film transistor substrate 111.

The liquid crystal panel 113 is a laminate of the above-mentioned substrates, and is provided in the lower receptacle 160, which will be described below.

The gate tape carrier package 114 is connected to the gate lines (not shown) formed on the thin film transistor substrate 111, and the data tape carrier package 115 is connected to the data lines (not shown) formed on the thin film transistor substrate 111.

The printed circuit board 116 is mounted with various parts that process all of the gate driving signals and the data driving signals for enabling the gate driving signals and the data driving signals to be input to the gate tape carrier package 114 and the data tape carrier package 115, respectively.

The light guide plate 130 is provided such that at least one side faces the light source package 1000 and guides light emitted from the light source package 1000. The light guide plate 130 may be formed of a translucent material capable of effectively guiding light, for example, an acrylic resin, such as PMMA (polymethyl methacrylate), or a material having a constant reflective index, such as polycarbonate (PC).

Light is incident on at least one side of the light guide plate 130 made of the above-mentioned material at an angle within the threshold angle of the light guide plate 130. Therefore, the light is incident into the light guide plate 130. When light is incident on the upper surface or the lower surface of the guide plate 130, the incident angle of the light is beyond the threshold angle, and the light uniformly travels through light guide plate 130 without being emitted to the outside of the light guide plate 130. A scattering pattern (not shown) may be formed on at least one of the upper surface and the lower surface of the light guide plate 130. The scattering pattern scatters light incident on the upper surface or the lower surface of the light guide plate 130 to the liquid crystal panel 113.

The light source package 1000 may be provided on at least one side of the light guide plate 130. A point light source may be included in the light source package 1000 according to this embodiment, and an LED (light emitting diode) is used as an example of the point light source. In this embodiment, the LED is used as the light source, but the light source according to this embodiment is not limited to the LED.

The light source package 1000 according to this embodiment may be an edge type that is provided on at least one side of the light guide plate 130. The light source package 1000 may be provided on only one side of the light guide plate 130, or the light source packages may be provided on both sides of the light guide plate 130. A plurality of light source packages 1000 may be arranged at predetermined intervals on the alignment plate 120. Power is supplied to the light source packages 1000 through external power supply terminals 121 formed on the alignment plate 120.

Light emitted from the light source package 1000 passes through the light guide plate 130 and the optical sheet 140. The detailed structure of the light source package 1000 will be described in detail below.

At least one optical sheet 140 may be provided on the light guide plate 130. The optical sheet 140 may include a diffusion sheet 141, a prism sheet 142, and a protective sheet 143.

The diffusion sheet 141 is provided on the light guide plate 130 and improves the brightness uniformity of light incident from the light source package 1000. That is, the diffusion sheet 141 diffuses light incident from the light source package 1000 and prevents light from being locally focused.

The prism sheet 142 is provided on the diffusion sheet 141. The prism sheet focuses light diffused by the diffusion sheet 141 and emits the focused light. The prism sheet 142 may include first and second prism sheets having prism patterns that intersect each other. However, when only the first prism sheet can be used to ensure sufficient brightness and viewing angle, the second prism sheet may be omitted.

The protective sheet 143 may be provided on the prism sheet 142. The protective sheet can not only protect the surface of the prism sheet 142, but also diffuse light to obtain a uniform light distribution.

The reflecting sheet 150 is provided at a lower part of a lower receptacle 160, and reflects light components that do not travel toward the liquid crystal panel 113 but are emitted from the lower surface of the light source package 1000 to the upper side.

The reflecting sheet 150 may be manufactured by dispersing a white pigment, such as titanium oxide, in a synthetic resin sheet. Air bubbles may be dispersed in the synthetic resin sheet in order to scatter light.

The reflecting sheet 150, the optical sheet 140, the light guide plate 130, and the liquid crystal panel 113 are accommodated in the lower receptacle 160.

The upper receptacle 170 is provided on the liquid crystal panel 113 so as to cover the upper surface of the liquid crystal panel 113.

A window is formed in the upper surface of the upper receptacle 170 such that the liquid crystal panel 113 is exposed to the outside. The upper surface of the upper receptacle 170 may be bent downward to press the upper edge of the liquid crystal panel 113.

The upper receptacle 170 may be coupled to the lower receptacle 160 by screws (not shown) and/or hooks (not shown).

Referring to FIGS. 1 to 3A, the light source package 1000 includes a package case (1410, 1420, 1460, 1470, and 1480) and light sources 1100 provided in the package case (1410, 1420, 1460, 1470, and 1480). In this embodiment, an LED (light emitting diode) is used as an example of the light source 1100, but the light source according to this embodiment is not limited thereto.

The LED, serving as the light source 1100, includes a first conductive layer, a light-emitting layer, and a second conductive layer sequentially formed on a substrate. In the light-emitting layer, carriers (for example, electrons) in the first conductive layer and carriers (for example, holes) in the second conductive layer are coupled to emit light.

The light source 1100 is mounted to lead frames 1210 and 1220, which will be described below. The lead frames 1210 and 1220 connect the light source 1100 to a light source mounting plate 1460 and serve as electrodes of the light source 1100. The light source 1100 is connected to the lead frames 1210 and 1220 by wires 1310 and 1320, respectively.

In this embodiment, a white LED is used as an example of the light source 1100, but the present invention is not limited thereto. For example, a red, green, or blue LED or a combination thereof may be used as the light source.

The light source package 1000 may have a trapezoidal shape in a cross-sectional view. In this case, the light source package may have a package reflecting portion 1480 that protrudes from the center of the trapezoid upward.

The package case (1410, 1420, 1460, 1470, and 1480) includes a bottom plate (1410 and 1480) including a bottom plate flat portion 1410 and a light source mounting plate 1460 that is formed by bending at least one end of the bottom plate flat portion 1410 and has a first inclination angle θ₁ with respect to the bottom plate portion 1410. In order to prevent irregular chromaticity, the light source mounting plates 1460 may be formed by bending both ends of the bottom plate flat portion 1410. A connecting portion X between the light source mounting plate 1460 and the bottom plate flat portion 1410 may have a small thickness for easy bending. In this embodiment, the first inclination angle θ₁ may be an obtuse angle, or it may be an acute angle, as in a modification of the first embodiment of the present invention, which will be described below.

The first inclination angle θ₁ formed between the light source mounting plate 1460 and the bottom plate flat portion 1410 may be in a range of about 90 to about 150° such that uniform light can reach the center of the light source package 1000 that is distant from the light source 1100. That is, an angle between a plane vertical to the bottom plate flat portion 1410 and the light source mounting plate 1460 may be in a range of about 0 to about 60°. In this case, the quantity of light emitted from the light source 1100 mounted to the light source mounting plate 1460 to the center of the light source package 1000 (ray directions b and c in FIG. 3A) may be more than that emitted in the vertical direction (ray direction a in FIG. 3A). That is, when the light source mounting plate 1460 is arranged at the first inclination angle θ₁ with respect to the bottom plate flat portion 1410, the quantity of light emitted to the center of the light source package 1000 (ray directions b and c in FIG. 3A) may be more than that when the light source mounting plate 1460 is arranged in parallel to the bottom plate flat portion 1410.

The package reflecting portion 1480 that reflects light emitted form the light source 1100 may be provided in the package case (1410, 1420, 1460, 1470, and 1480). The package reflecting portion 1480 is provided in the package case (1410, 1420, 1460, 1470, and 1480) so as to have a second inclination angle θ₂ with respect to the bottom plate flat portion 1410. The second inclination angle θ₂ may be smaller than 45° such that light reflected from the package reflecting portion 1480 is effectively emitted in a direction vertical to the bottom plate flat portion 1410.

The second inclination angle θ₂ may be fixed, or it may vary depending on the distance from the bottom plate flat portion 1410. That is, as the distance from the bottom plate flat portion 1410 is increased, the second inclination angle θ₂ may be increased or decreased.

The second inclination angle θ₂ may vary depending on the first inclination angle θ₁ such that light emitted from the light source 1100 is uniformly emitted from the entire emission surface facing the bottom plate flat portion 1410.

The package reflecting portion 1480 reflects light emitted from the light source 1100 upward. In this embodiment, the package reflecting portion 1480 is a convex pattern that protrudes from the bottom plate flat portion 1410 to the inside of the package case (1410, 1420, 1460, 1470, and 1480). The package reflecting portion 1480 may have a trigonal prism shape, but the present invention is not limited thereto. The package reflecting portion 1480 may be formed by providing a reflective material on the bottom plate flat portion 1410 or by bending the bottom plate (1410 and 1480). In this embodiment, as the package reflecting portion 1480, a single convex pattern having a trigonal prism shape is formed on the bottom plate flat portion 1410. However, the shape and material forming the package reflecting portion 1480, and the number of package reflecting portions are not limited thereto.

Light emitted from the light source mounting plate 1460 having the first inclination angle θ₁ with respect to the bottom plate flat portion 1410 travels in the horizontal direction to the center of the package case (1410, 1420, 1460, 1470, and 1480) and is reflected from the package reflecting portion 1480. In this way, light emitted from the light sources 1100 provided at both sides of the light source package 1000 can be uniformly emitted from the entire emission surface of the light source package 1000 facing the bottom plate flat portion 1410. Arrows represented in a radial shape show light components that are uniformly emitted from the entire emission surface.

FIG. 3B is a diagram schematically illustrating a light source package of a liquid crystal display device according to a modification of the first embodiment of the present invention.

Referring to FIG. 3B, a light source mounting plate 1460 of the liquid crystal display device according to the modification of the first embodiment of the present invention may have the first inclination angle θ₁, which is an acute angle, with respect to the bottom plate flat portion 1410. In this case, the area of a vertical side wall 1420 is decreased by a value that is proportional to the bending angle of the light source mounting plate 1460, and the connection side wall 1470 may be omitted. In this embodiment, the first inclination angle θ₁ may be in a range of about 30 to about 90°.

A second inclination angle −θ₂ formed between the package reflecting portion 1480 and the bottom plate flat portion 1410 may vary depending on the first inclination angle θ₁, and the package reflecting portion may have a concave pattern. Light emitted from the light source 1100 can be uniformly emitted from the entire emission surface facing the bottom plate flat portion 1410 by changing the first inclination angle θ₁, which is an acute angle, depending on the second inclination angle −θ₂.

When the first inclination angle θ₁ is an acute angle, the shape of the package reflecting portion 1480 is not limited to the concave shape. In this case, the package reflecting portion may still have a convex shape, or it may be substantially parallel to the bottom plate flat portion 1410.

The package case (1410, 1420, 1460, 1470, and 1480) may further include package side walls (1420 and 1470) connecting the bottom plate flat portion 1410 and the edge of the light source mounting plate 1460. The package side walls (1420 and 1470) include vertical side walls 1420 that are provided along both sides of the bottom plate flat portion 1410 and face each other, and connection side walls 1470 that are provided along both sides of the light source mounting plate 1460 and are coupled to the vertical side walls 1420. The vertical side walls 1420 and the connection side walls 1470 may be coupled to each other by fitting protruding portions 1470a into engaging grooves 1420a. In this way, the vertical side walls 1420 and the connection side walls 1470 are tightly coupled to each other such that no protective resin 1500 leaks to the outside.

The package case (1410, 1420, 1460, 1470, and 1480) may be formed of a plastic resin. The package case (1410, 1420, 1460, 1470, and 1480) may be formed of an organic material providing electrical insulation and having low light absorbance, such as silicon resin, epoxy resin, acrylic resin, fluororesin, or (Poly)-imide resin, or an inorganic material having low light absorbance, such as glass or silica gel. In addition, the package case (1410, 1420, 1460, 1470, and 1480) may be formed of a thermosetting resin in order to prevent resin from being melted by heat during manufacture.

At least a portion of the package case (1410, 1420, 1460, 1470, and 1480) is filled with the protective resin 1500. As the protective resin 1500, for example, any of the following resins may be used: epoxy resin, silicon resin, hard silicon resin, modified silicon resin, urethane resin, oxetane resin, acrylic resin, polycarbonate resin, and polyimide resin. In this embodiment, the upper surface of the protective resin 1500 may be flat, but the present invention is not limited thereto.

A metal reflecting layer (not shown) may be provided on the inner side surface of the package case (1410, 1420, 1460, 1470, and 1480) in order to improve reflectance.

At least a portion of the protective resin 1500 may include a fluorescent material 1600. The fluorescent material 1600 may include a transparent resin and a phosphor. The phosphor absorbs light emitted form the light source 1100 and converts it into light having a different wavelength. Any material may be used as the phosphor as long as it can absorb light emitted from the light source 1100 and convert it into light having a different wavelength. For example, the phosphor is preferably at least one selected from the following materials: a nitride-based phosphor or an oxynitride-based phosphor that is mainly activated by a lanthanoid element, such as Eu or Ce; an alkaline earth element halogen apatite phosphor, an alkaline earth metal element boride halogen phosphor, an alkaline earth metal element aluminate phosphor, alkaline earth element silicate, alkaline earth element sulfide, alkali earth element thiogallate, alkaline earth element silicon nitride, and germanate that are mainly activated by a lanthanoid element, such as Eu, or a transition metal element, such as Mn; rare earth aluminate and rare earth silicate that are mainly activated by a lanthanoid element, such as Ce; and an organic compound and an organic complex that are mainly activated by a lanthanoid element, such as Eu. The transparent resin is not particularly limited as long as it can uniformly disperse phosphors. For example, as the transparent resin, any of the following resins may be used: epoxy resin, silicon resin, hard silicon resin, modified silicon resin, urethane resin, oxetane resin, acrylic resin, polycarbonate resin, and polyimide resin.

In this embodiment, the fluorescent material 1600 is uniformly formed on the entire protective resin, but the present invention is not limited thereto.

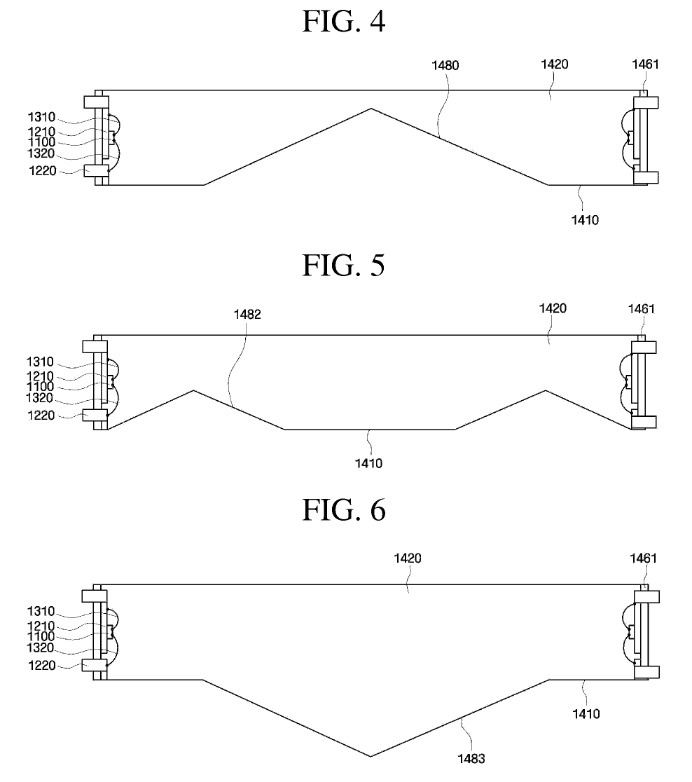

Next, a liquid crystal display device according to a second embodiment of the present invention will be described with reference to FIG. 4. For convenience of description, in this embodiment, the same components as those in the first embodiment of the present invention are denoted by the same reference numerals. Therefore, the same components will be briefly described, or a description thereof will be omitted. FIG. 4 is a diagram schematically illustrating a light source package of the liquid crystal display device according to the second embodiment of the present invention.

Referring to FIG. 4, in the light source package according to this embodiment, the bottom plate flat portion 1410 is arranged substantially vertical to a light source mounting plate 1461. That is, the light source mounting plate 1461 is formed by bending at least one end of the bottom plate flat portion 1410 such that an angle formed between the light source mounting plate 1461 and the bottom plate flat portion 1410 is 90°. In this case, light emitted from the light source 1100 according to this embodiment of the present invention can easily travel to the center of the light source package 1000 that is distant from the light source 1100.

Next, a liquid crystal display device according to a third embodiment of the present invention will be described with reference to FIG. 5. For convenience of description, in this embodiment, the same components as those in the first or second embodiment of the present invention are denoted by the same reference numerals. Therefore, the same components will be briefly described, or a description thereof will be omitted. FIG. 5 is a diagram schematically illustrating a light source package of the liquid crystal display device according to the third embodiment of the present invention.

This embodiment is similar to the first and second embodiments of the present invention except for a package reflecting portion 1482. In the light source package according to this embodiment, the light source mounting plate 1461 is arranged substantially vertical to the bottom plate flat portion 1410. However, as shown in FIG. 3A, the light source mounting plate 1461 may be formed so as to be inclined. Referring to FIG. 5, the package reflecting portion 1482 according to this embodiment includes a pair of light-reflective elements having a convex pattern. Said light-reflecting elements are formed at both sides of the bottom plate flat portion 1410 so as to be spaced from each other.

Next, a liquid crystal display device according to a fourth embodiment of the present invention will be described with reference to FIG. 6. FIG. 6 is a diagram schematically illustrating a light source package of the liquid crystal display device according to the fourth embodiment of the present invention.

This embodiment is similar to the third embodiment of the present invention except for a package reflecting portion 1483. Referring to FIG. 6, the package reflecting portion 1483 according to this embodiment has a concave pattern that protrudes from the bottom plate flat portion 1410 to the outside of a package case (1410, 1420, 1460, 1470, and 1480). The package reflecting portion 1483 according to this embodiment may be formed by bending the bottom plate flat portion 1410 downward in a concave shape.

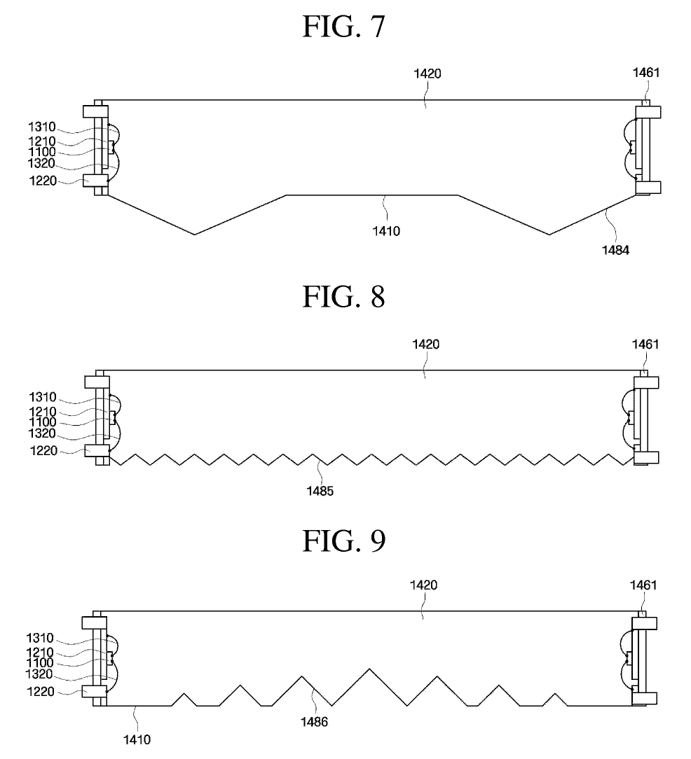

Next, a liquid crystal display device according to a fifth embodiment of the present invention will be described with reference to FIG. 7. FIG. 7 is a diagram schematically illustrating a light source package of the liquid crystal display device according to the fifth embodiment of the present invention.

This embodiment is similar to the fourth embodiment of the present invention except for a package reflecting portion 1484. Referring to FIG. 7, the package reflecting portion 1484 according to this embodiment includes a pair of light-reflecting elements having a convex pattern. Said light-reflecting elements are formed at both sides of the bottom plate flat portion 1410 so as to be spaced from each other.

Next, a liquid crystal display device according to a sixth embodiment of the present invention will be described with reference to FIG. 8. FIG. 8 is a diagram schematically illustrating a light source package of the liquid crystal display device according to the sixth embodiment of the present invention.

This embodiment is similar to the third embodiment of the present invention except for a package reflecting portion 1485. Referring to FIG. 8, in this embodiment, the package reflecting portion 1485 is formed from a plurality of light-reflecting elements having the same size. The light-reflecting elements comprise a plurality of convex patterns. The package reflecting portion 1485 according to this embodiment is formed along the entire bottom plate 1485 of the light source package.

Next, a liquid crystal display device according to a seventh embodiment of the present invention will be described with reference to FIG. 9. FIG. 9 is a diagram schematically illustrating a light source package of the liquid crystal display device according to the seventh embodiment of the present invention.

This embodiment is similar to the third embodiment of the present invention except for a package reflecting portion 1486. Referring to FIG. 9, in this embodiment, the package reflecting portion 1486 is formed from a plurality of light-reflecting elements having a convex pattern, such patterns having different sizes. The light-reflecting element provided at the center of the light source package has the largest size, and the size of the package reflecting portion is reduced as a distance from the center is increased.

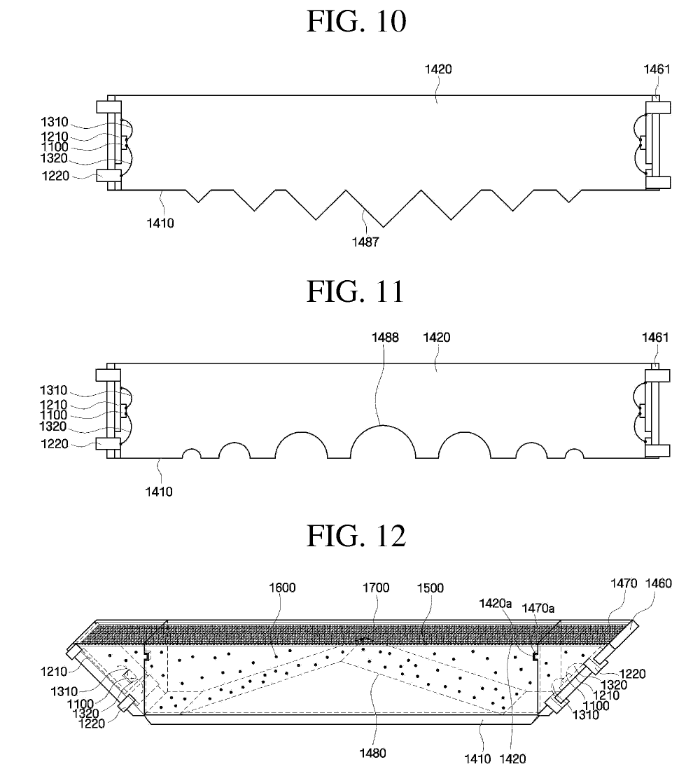

Next, a liquid crystal display device according to an eighth embodiment of the present invention will be described with reference to FIG. 10. FIG. 10 is a diagram schematically illustrating a light source package of the liquid crystal display device according to the eighth embodiment of the present invention.

This embodiment is similar to the seventh embodiment of the present invention except for a package reflecting portion 1487. The package reflecting portion 1487 consists of a plurality of light-reflecting elements that have a concave pattern, whereby the light-reflecting element provided at the center of the light source package has the largest size, and the sizes of the light-reflecting elements are reduced as their distance from the center of the light source package is increased.

Next, a liquid crystal display device according to a ninth embodiment of the present invention will be described with reference to FIG. 11. FIG. 11 is a diagram schematically illustrating a light source package of the liquid crystal display device according to the ninth embodiment of the present invention.

This embodiment is similar to the seventh embodiment of the present invention except for a package reflecting portion 1488. The package reflecting portion 1488 consists of a plurality of light-reflecting elements having a convex pattern. According to this embodiment, the light-reflective elements have a cylindrical shape whereby the cylinder axis lies in the plane of the bottom plate flat portion 1410 and is perpendicular to the package sidewalls 1420. Said light-reflecting elements are arranged such that the light-reflective element provided at the center of the light source package has the largest size, and the sizes of the light-reflecting elements are reduced as their distance from the center of the light source package is increased.

Next, a liquid crystal display device according to a tenth embodiment of the present invention will be described with reference to FIG. 12. FIG. 12 is a diagram schematically illustrating a light source package of the liquid crystal display device according to the tenth embodiment of the present invention.

This embodiment is similar to the first embodiment of the present invention except that this embodiment further includes a bead layer or a protective resin layer 1700 subjected to a surface treatment. Referring to FIG. 12, the bead layer or the protective resin layer 1700 subjected to a surface treatment is formed by laminating a bead layer made of, for example, transparent silicon on the upper surface of the protective resin 1600 or by subjecting the protective resin 1600 to a surface treatment to increase the roughness of the protective resin. In this way, it is possible to prevent light emitted from the light source package from being reflected back into the light source package due to total reflection, by further adjusting the emission angle of light from the light source package. As a result, it is possible to improve emission efficiency of the light source package.

Next, a liquid crystal display device according to an eleventh embodiment of the present invention will be described with reference to FIG. 13. FIG. 13 is a diagram schematically illustrating a light source package of the liquid crystal display device according to the eleventh embodiment of the present invention.

This embodiment is similar to the first embodiment of the present invention except for the arrangement of a fluorescent material 1610. Referring to FIG. 13, the fluorescent material 1610 according to this embodiment is mixed with the resin 1500.

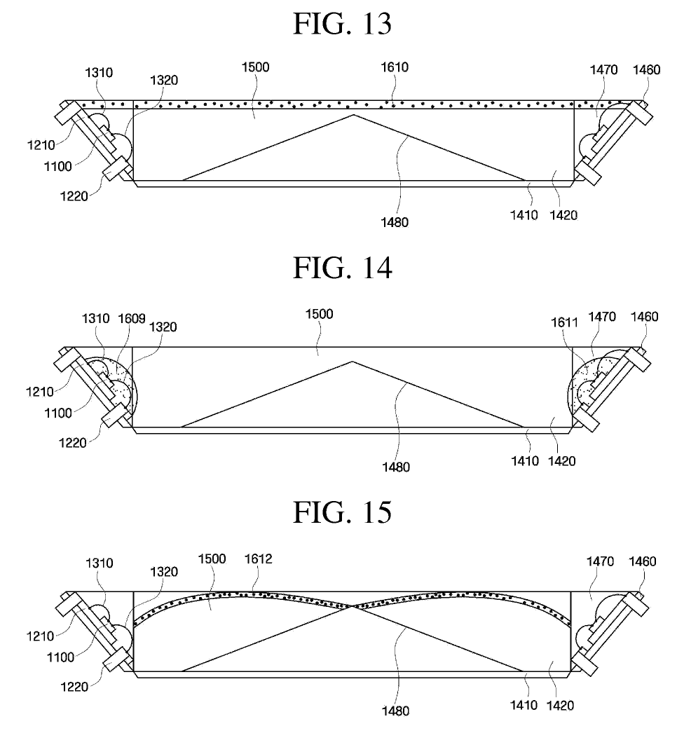

Next, a liquid crystal display device according to a twelfth embodiment of the present invention will be described with reference to FIG. 14. FIG. 14 is a diagram schematically illustrating a light source package of the liquid crystal display device according to the twelfth embodiment of the present invention.

This embodiment is similar to the first embodiment of the present invention except for the arrangement of a fluorescent material 1611. Referring to FIG. 14, the fluorescent material 1611 according to this embodiment is arranged so as to form a volume of limited size around the light source 1100.

Next, a liquid crystal display device according to a thirteenth embodiment of the present invention will be described with reference to FIG. 15. FIG. 15 is a diagram schematically illustrating a light source package of the liquid crystal display device according to the thirteenth embodiment of the present invention.

This embodiment is similar to the first embodiment of the present invention except for the shape of the upper surface of the protective resin 1500 and the arrangement of a fluorescent material 1612. According to this embodiment, the upper surface of the protective resin 1500 has a lens shape. The fluorescent material 1612 is placed only at an upper part of the protective resin 1500.

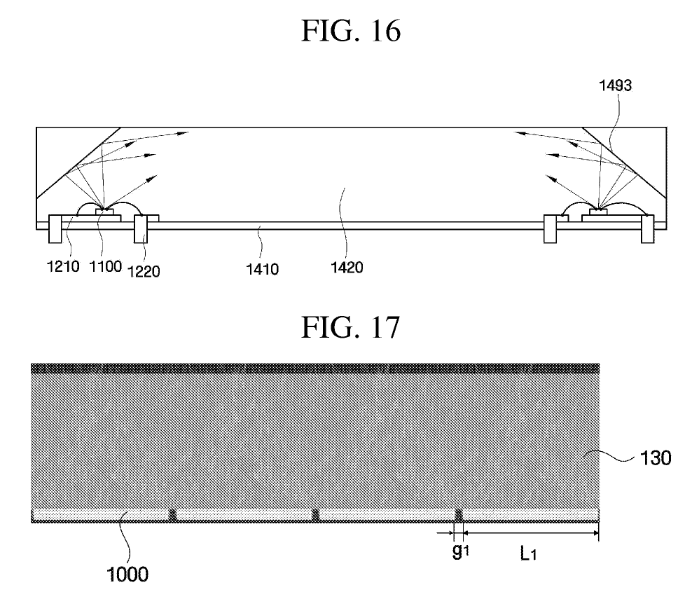

Next, a liquid crystal display device according to a fourteenth embodiment of the present invention will be described with reference to FIG. 16. FIG. 16 is a diagram schematically illustrating a light source package of the liquid crystal display device according to the fourteenth embodiment of the present invention.

The light source 1100 according to this embodiment is provided on a bottom plate flat portion 1410. That is, a package case (1410 and 1420) according to this embodiment includes a bottom plate flat portion 1410 and a plurality of package side walls 1420 that are formed along the edge of the bottom plate flat portion 1410, and the light source 1100 is mounted on the bottom plate flat portion 1410, on the edge of the light source package. Therefore, the light source 1100 is not inclined with respect to the bottom plate 1410.

The light source package according to this embodiment includes a package reflecting portion 1493 that is inclined with respect to the bottom plate 1410 and reflects light emitted from the light source 1100. The package reflecting portion 1493 according to this embodiment is connected to the upper parts of a plurality of package side walls 1420 and is inclined with respect to the bottom plate flat portion 1410. That is, the light source 1100 according to this embodiment is provided on the bottom plate flat portion 1410, and light emitted from the light source 1100 to the upper surface of the light source package is reflected from the package reflecting portion 1493 to the center of the light source package. In this way, light is uniformly emitted from the entire emission surface of the light source package. Two or more light sources 1100 may be provided in one light source package.

As shown in FIG. 1, a plurality of light source packages 1000 according to this embodiment, are provided along at least one side of a light guide plate 130. The ratio of the length of the light source package 1000 to a gap between the plurality of light source packages 1000 may be in a range of about 4:1 to about 30:1.

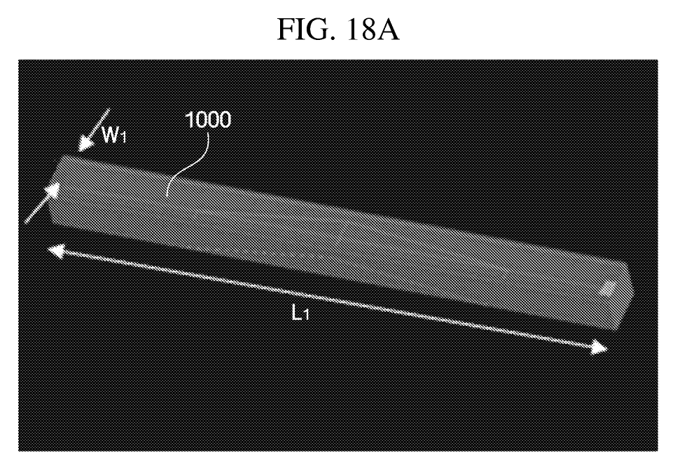

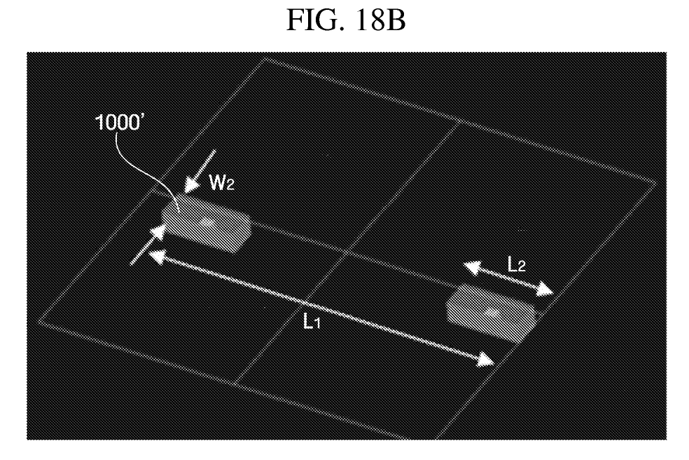

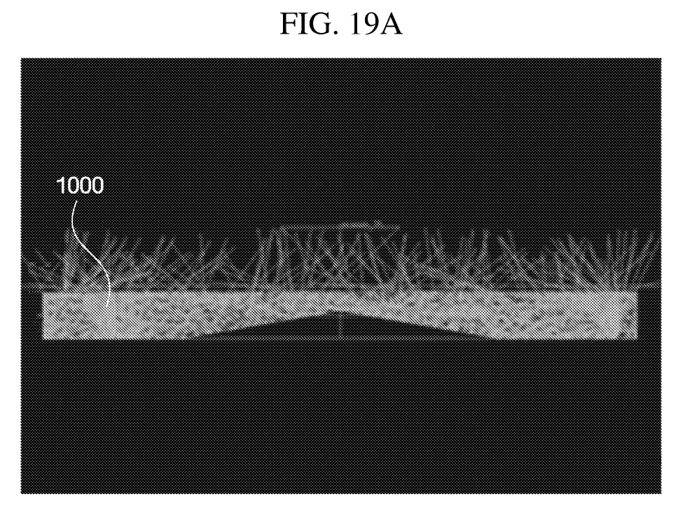

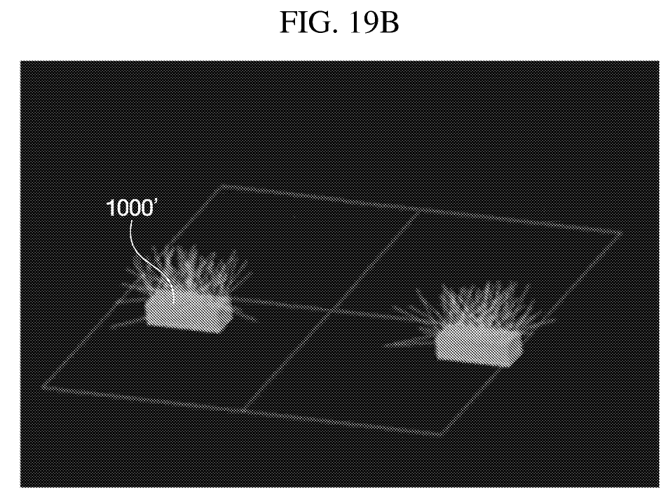

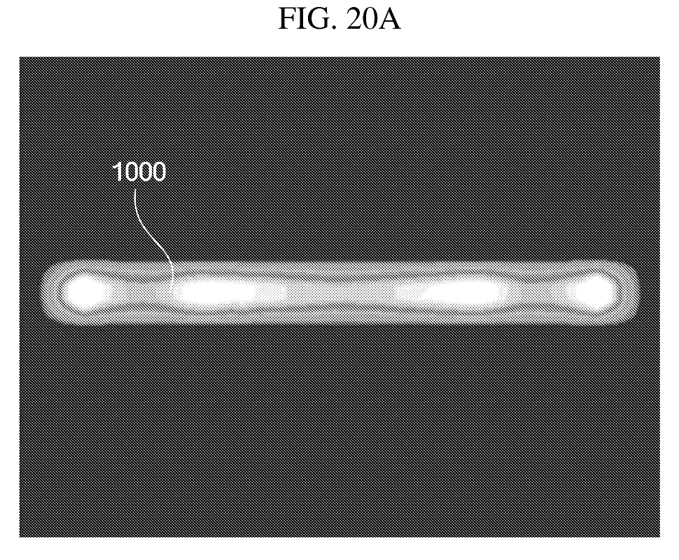

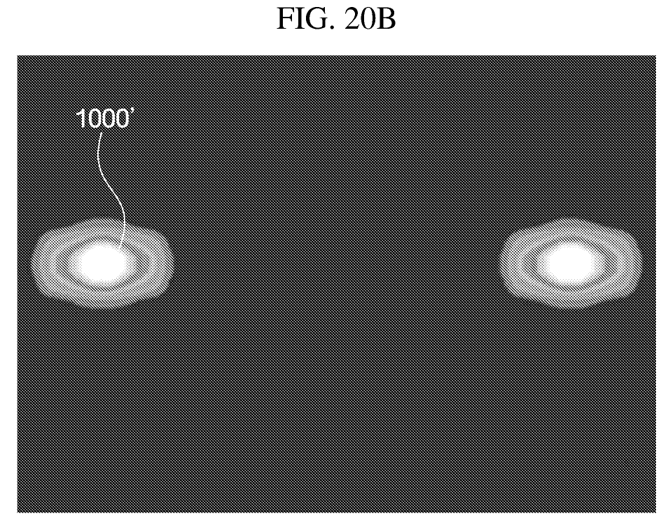

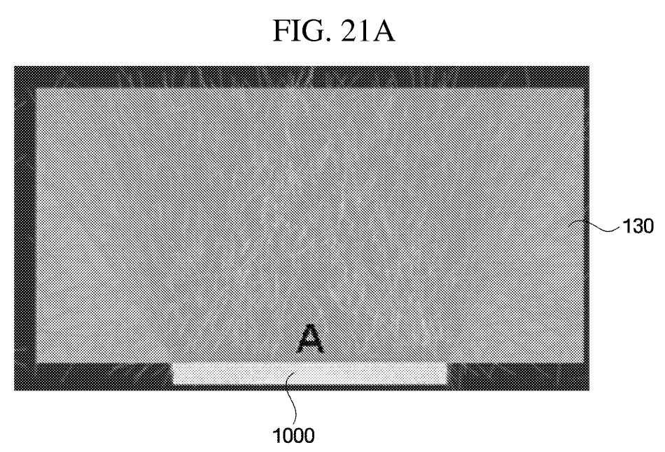

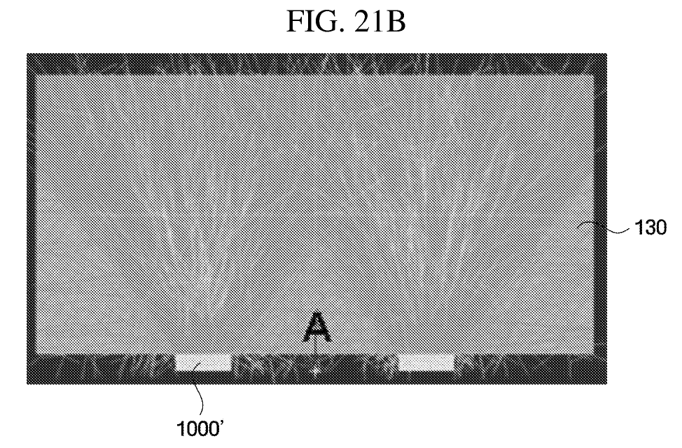

Next, the characteristics of the liquid crystal display devices according to the first to fourteenth embodiments of the present invention will be described with reference to FIGS. 17 to 21B. FIG. 17 is a diagram illustrating the gaps between the light source packages according to the embodiments of the present invention. FIGS. 18A and 18B are diagrams schematically illustrating the length of the light source package according to the embodiments of the present invention and the length of a light source package according to a comparative example. FIGS. 19A and 19B are diagrams schematically illustrating the brightness distribution of the light source package according to the embodiments of the present invention and the brightness distribution of the light source package according to the comparative example. FIGS. 20A and 20B are diagrams schematically illustrating the light quantity distribution of the light source package according to the embodiments of the present invention and the light quantity distribution of the light source package according to the comparative example. FIGS. 21A and 21B are diagrams schematically illustrating the area of a dark portion in the liquid crystal display device according to the embodiments of the present invention and the area of a dark portion in a liquid crystal display device according to the comparative example.

First, referring to FIGS. 17 to 18B, a plurality of light source packages 1000 may be provided along at least one side of the light guide plate 130 (cf. FIG. 1), and the ratio of the length L1 of the light source package 1000 to a gap g1 between the plurality of light source packages 1000 may be in a range of about 4:1 to about 30:1. Specifically, the length L1 of the light source package 1000 may be in a range of about 20 to about 30 mm. When the length L1 of the light source package 1000 is in the above-mentioned range, it is possible to drive the liquid crystal display device using a small number of light source packages 1000, which results in a reduction in manufacturing costs. When the length L1 of the light source package 1000 is larger than the above-mentioned range, it is difficult to emit uniform light from the entire surface of the light source package 1000. When the length L1 of the light source package 1000 is smaller than the above-mentioned range, a large number of light source packages 1000 need to be provided in the liquid crystal display device, and it is difficult to reduce manufacturing costs. In this embodiment, the length L1 of the light source package 1000 is larger than the length L2 of a light source package 1000′ according to the comparative example (cf. FIGS. 18A and 18B). Therefore, since a longer light source package 1000 is used to emit light to the liquid crystal display device, it is possible to reduce the area of a dark portion. In the comparative example depicted in FIGS. 18B, 19B, 20B, and 21B, the light source package is provided on a bottom plate, and when the length L2 of the light source package is large, the emission distribution of the light source package 1000′ is not uniform. Since the distance between the outer ends of two light source packages 1000′ according to the comparative example is the same as the length L1 of the light source package 1000 according to this embodiment, the comparative example requires a large number of light source packages 1000 provided in the liquid crystal display device. The width W1 of the light source package 1000 according to this embodiment may be equal to the width W2 of the light source package 1000′ according to the comparative example.

The gap g1 between the light source packages 1000 may be in a range of about 1 to about 5 mm. If the gap g1 between the light source packages 1000 is smaller than the above-mentioned range, a large number of light source packages 1000 need to be provided in the liquid crystal display device increasing manufacturing costs. If the gap g1 between the light source packages 1000 is larger than the above-mentioned range, the area of a dark portion is excessively large, and a brightness variation between different portions of the liquid crystal display device will be seen by a viewer.

Referring to FIGS. 19A and 19B, as can be seen from FIG. 19A showing the light source package according to one of the embodiments of the present invention, in particular according to the embodiment depicted in FIG. 4, one light source package having a relatively large length has a uniform emission distribution. In contrast, as can be seen from FIG. 19B showing the light source packages according to the comparative example of FIG. 18B, the light source packages, each having a relatively small length, have a uniform emission distribution, but a dark portion is formed in the gap between the light source packages.

Referring to FIGS. 20A and 20B, as can be seen from FIG. 20A showing the light source package according to on of the embodiments of the present invention, in particular, the embodiment depicted in FIG. 4, one light source package having a relatively large length has a uniform emission distribution. In contrast, as can be seen from FIG. 20B showing the light source packages according to the comparative example depicted in FIG. 18B, the light source packages, each having a relative small length, have a uniform light quantity distribution, but a dark portion is formed in the gap between the light source packages.

Referring to FIGS. 21A and 21B, as can be seen from FIG. 21A showing the light source package according to the embodiments of the present invention, in particular, the embodiment depicted in FIG. 4, one light source package having a relatively large length has a uniform emission distribution, and no dark portion is formed in an area A. In contrast, as can be seen from FIG. 21B showing the light source packages according to the comparative example depicted in FIG. 18B, a plurality of light source packages, each having a relative small length, are provided, and a dark portion is formed in the same area A as that in FIG. 20A.

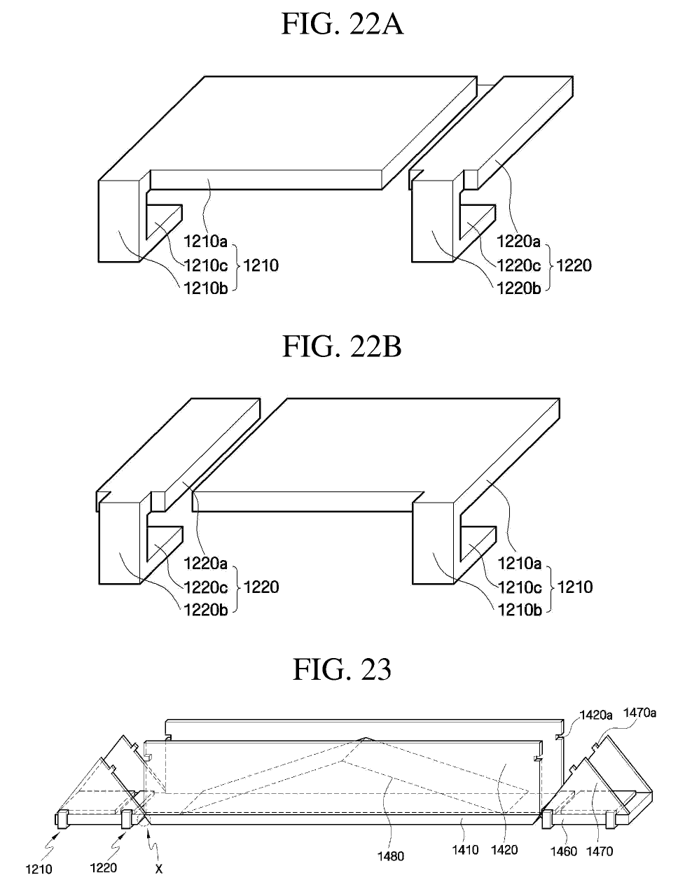

Next, a method of manufacturing a liquid crystal display device according to a fifteenth embodiment of the present invention will be described with reference to FIG. 1 and FIGS. 22A and 22B to 28. FIGS. 22A and 22B to 28 are diagrams illustrating processes of the method of manufacturing the liquid crystal display device according to the fifteenth embodiment of the present invention.

First, referring to FIGS. 1, 22A, and 22B, two sets of lead frames 1210 and 1220 are provided. The lead frames 1210 and 1220 are coupled to the light source mounting plates (see reference numeral 1460 in FIG. 23) at both ends of the package case (1410, 1420, 1460, 1470, and 1480) and serve as electrodes of the light sources 1100.

The lead frames 1210 and 1220 include a first lead frame 1210 which has a relatively large size and to which the light source 1100 is directly mounted, and a second lead frame 1220 which serves as an opposite electrode. The lead frames 1210 and 1220 include mounting portions 1210a and 1220a provided on the upper surface of the light source mounting plate, connecting portions 1210b and 1220b respectively formed by bending the mounting portions 1210a and 1220a, and supporting portions 1210c and 1220c that are formed by bending the connecting portions 1210b and 1220b and are provided on the rear surface of the light source mounting plate.

The connecting portions 1210b and 1220b each have the same thickness as the light source mounting plate, and the mounting portions 1210a and 1220a and the supporting portions 1210c and 1220c are closely adhered to the upper and lower surfaces of the light source mounting plate, respectively. In this way, the lead frames 1210 and 1220 are coupled to the light source mounting plate.

Referring to FIG. 23, the package case (1410, 1420, 1460, 1470, and 1480) including the package reflecting portion 1480 is provided. Before being coupled to the bottom plate flat portion 1410, the light source mounting plates 1460 extend from both ends of the bottom plate flat portion 1410, and the light source mounting plates and the bottom plate flat portion 1410 are positioned on the same plane. The connecting portions X between the light source mounting plates 1460 and the bottom plate flat portion 1410 have a small thickness such that the light source mounting plates 1460 can be easily bent with respect to the bottom plate flat portion 1410. The package side walls (1420 and 1470) include the vertical side walls 1420 that are provided along both sides of the bottom plate flat portion 1410 and face each other, and the connection side walls 1470 that are provided along both sides of the light source mounting plate 1460 and also face each other. The engaging grooves 1420a and the protruding portions 1470a are formed in the vertical side walls 1420 and the connection side walls 1470, respectively.

The package reflecting portion 1480 may be formed by bending the bottom plate flat portion 1410, or a separate reflecting member may be provided on the bottom plate (1410 and 1480) so as to be inclined with respect to the bottom plate flat portion 1410.

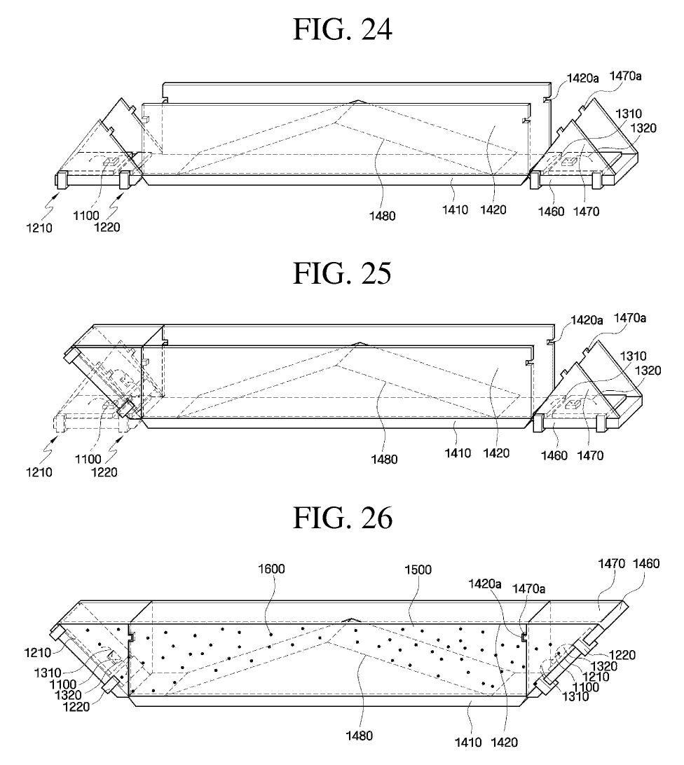

Referring to FIG. 24, the light source mounting plates 1460 positioned on the same plane as the bottom plate flat portion 1410 are coupled to the lead frames 1210 and 1220, and each light source 1100 is mounted on the lead frames 1210 and 1220. Each of the light sources 1100 is connected to the lead frames 1210 and 1220 by wires 1310 and 1320, respectively.

Then, referring to FIG. 25, the light source mounting plates 1460 are bent to couple the connection side walls 1470 to the vertical side walls 1420. That is, the protruding portions 1470a formed on the connection side walls 1470 are fitted into the engaging grooves 1420a formed in the vertical side walls 1420, thereby forming the package side walls (1420 and 1470).

The above-mentioned processes provide the package case (1410, 1420, 1460, 1470, and 1480) including the bottom plate flat portion 1410 and the light source mounting plate 1460 that is formed by bending at least one end of the bottom plate (1410 and 1480) and has the first inclination angle θ₁ with respect to the bottom plate flat portion 1410, and the package reflecting portion 1480 that is provided in the package case (1410, 1420, 1460, 1470, and 1480) so as to have the second inclination angle −θ₂ with respect to the bottom plate flat portion 1410.

Then, referring to FIG. 26, the protective resin 1500 is filled in the package case (1410, 1420, 1460, 1470, and 1480), and the fluorescent material 1600 is mixed with the protective resin. This embodiment may further comprise a process of forming a bead layer or a protective resin layer(see FIG. 12) subjected to a surface treatment on the protective resin 1500.

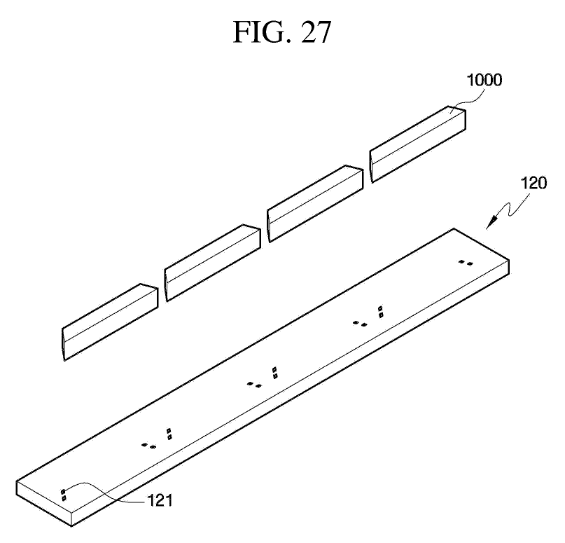

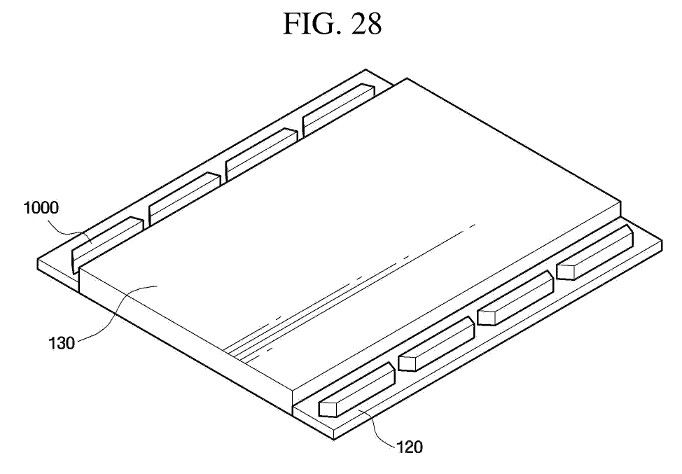

Then, referring to FIGS. 22A, 22B, and 27, the light source packages 1000 are arranged on the alignment plate 120 such that the lead frames 1210 and 1220 contact the external power supply terminals 121 of the alignment plate 120.

Then, referring to FIG. 28, a plurality of light source packages 1000 are arranged along at least one side of the light guide plate 130. In this case, the ratio of the length of the light source package 1000 to the gap between the plurality of light source packages 1000 arranged on the alignment plate 120 may be in a range of about 4:1 to about 30:1.

While the present invention has been particularly shown and described with reference to exemplary embodiments thereof, it will be understood by those of ordinary skill in the art that various changes in form and details may be made therein, without departing from the spirit and scope of the present invention as defined by the following claims.

What is claimed is:

1. A light source package comprising:
a package case including a bottom plate having a bottom plate flat portion, and a light source mounting plate that is formed by bending at least one end of the bottom plate and has a first inclination angle with respect to the bottom plate flat portion;
a light source mounted on the light source mounting plate; and
a package reflecting portion formed in the package case so as to have a second inclination angle with respect to the bottom plate flat portion and reflecting light emitted from the light source.

2. The light source package of claim 1, wherein the package reflecting portion has one or more convex or concave patterns that protrude from the bottom plate flat portion to the inside or outside of the package case.

3. The light source package of claim 2, wherein the plurality of convex or concave patterns are arranged such that the sizes thereof are gradually increased as the convex or concave portions are close to the center of the bottom plate, or the convex or concave portions have the same size.

4. The light source package of claim 2, wherein the plurality of convex or concave patterns have a trigonal prism shape or a cylindrical shape.

5. The light source package of claim 2, wherein the package reflecting portion is provided on the bottom plate or it is formed by bending the bottom plate.

6. The light source package of claim 1, further comprising package side walls connecting the bottom plate and the edge of the light source mounting plate.

7. The light source package of claim 6, wherein the package side walls include:
vertical side walls formed along both sides of the bottom plate so as to face each other; and
connection side walls formed along both sides of the light source mounting plate and coupled to the vertical side walls.

8. The light source package of claim 1, wherein the first inclination angle is in a range of about 30 to about 150°.

9. The light source package of claim 1, further comprising a protective resin filled in the light source package, wherein an upper surface of the protective resin is flat or has a lens shape.

10. The light source package of claim 6, wherein the fluorescent material is mixed with the entire protective resin or only an upper part of the protective resin, or it is provided so as to surround only the light source.

11. A liquid crystal display device comprising:
a light guide plate;
at least one light source package provided on at least one side of the light guide plate; and
a lower receptacle accommodating the light guide plate and the light source package,
wherein the light source package comprises: a package case including a bottom plate having a bottom plate flat portion, and a light source mounting plate that is formed by bending at least one end of the bottom plate and has a first inclination angle with respect to the bottom plate flat portion; a light source mounted on the light source mounting plate; and a package reflecting portion formed in the package case so as to have a second inclination angle with respect to the bottom plate flat portion and reflecting light emitted from the light source.

12. The liquid crystal display device of claim 11, wherein:
a plurality of light source packages are provided along at least one side of the light guide plate; and
the ratio of the length of each light source package to a gap between the plurality of light source packages is in a range of about 4:1 to about 30:1.

13. The liquid crystal display device of claim 11, wherein the package reflecting portion has one or more convex or concave patterns that protrude from the bottom plate to the inside or outside of the package case.

14. The liquid crystal display device of claim 11, wherein the light source package further includes package side walls connecting the bottom plate and the edge of the light source mounting plate.

15. The liquid crystal display device of claim 14, wherein the package side walls include:
vertical side walls formed along both sides of the bottom plate so as to face each other; and
connection side walls formed along both sides of the light source mounting plate and coupled to the vertical side walls.

16. The liquid crystal display device of claim 11, wherein the first inclination angle is in a range of about 30 to about 150°.

17. The liquid crystal display device of claim 11, further comprising a protective resin filled in the light source package, wherein an upper surface of the protective resin is flat or has a lens shape.

18. The liquid crystal display device of claim 17, further comprising a bead layer or a protective resin layer subjected to a surface treatment that is formed on the protective resin.

19. The liquid crystal display device of claim 17, further comprising a fluorescent material mixed with at least a portion of the protective resin.
